(19) United States
(12) Patent Application Publication
(10) Pub. No.: US 2013/0261813 A1
(43) Pub. Date: Oct. 3, 2013

(54) VALVE SYSTEM

(71) Applicants: Bjarne Wittendorff Ibsen, Dubai (AE); Gitte Pedersen, Odense NV (DK); Mille Sveje Bøjgaard, Kobenhavn O (DK)

(72) Inventors: Bjarne Wittendorff Ibsen, Dubai (AE); Gitte Pedersen, Odense NV (DK); Mille Sveje Bøjgaard, Kobenhavn O (DK)

(73) Assignee: FLOWCON INTERNATIONAL A/S, Slagelse (DK)

(21) Appl. No.: 13/819,631

(22) PCT Filed: Aug. 30, 2011
(86) PCT No.: PCT/DK11/50329

§ 371 Date: Jun. 12, 2013

Related U.S. Application Data
(60) Provisional application No. 61/380,864, filed on Sep. 8, 2010.

(30) Foreign Application Priority Data
Sep. 1, 2010 (DK) PA 2010 70380

(51) Int. Cl. G05D 7/06

(52) U.S. Cl. CPC G05D 7/0635
USPC 700/282

(57) ABSTRACT

The invention relates to a valve system, in particular for controlling the liquid flow in a plant for central heating. The system may comprise one or more valve housings with at least two associated distinct inserts having different flow characteristics. The inserts comprise two types of means with regulable openings that serve as inlet and outlet, respectively, said means being provided with means for regulating the liquid flow, the differential pressure over the openings of that first means being changeable, whereby the area of the openings of the other means is changed to the effect that the differential pressure is regulated. The inserts are furthermore provided with means for the applied change in area by means of an activator that comprises an end which is exposed to the surroundings. A programmable regulator unit provided with motor can be coupled to the end of an activator on the insert. The regulator unit is programmed such that it is capable of regulating the activator in response to the flow characteristics of the insert and hence the liquid flow through the valve housing coupled to the control unit.

The invention relates to a valve system, in particular for controlling the liquid flow in a plant for central heating, which system comprises one or more valve bodies, wherein an insert can be arranged that has specific flow characteristics, said insert comprising two types of units with regulable openings, said units being provided with means for regulating the liquid flow, an applied change in the area of the openings of the one unit bringing about a change in the differential pressure over the openings of that unit, whereby the area of the openings of the other unit is changed in response thereto, said insert being furthermore provided with means for the applied change in area by means of an activator that comprises an end which is exposed to the surroundings.

WO 95/17622 teaches a valve for maintaining a constant liquid flow in a heating or cooling plant. That valve can be combined with a control unit, but today, during installation, the operator must convert the desired design flow into a setting of the control unit or the valve. That is a time-consuming process which involves a high risk of errors, both inasmuch as the conversion and the accuracy of the setting are concerned. That may entail that the liquid flow in the plant is not regulated optimally—with an ensuing probable loss of energy.

It is an object of the invention to provide a system whereby those drawbacks are minimised.

That is obtained by the valve system comprising a programmable regulator unit provided with motor and comprising coupling means adapted to complementary coupling means on the valve bodies to the effect that the motor of the regulator unit can optionally be coupled to the end of the activator of the insert, said regulator unit being programmed such that the regulator unit is capable of regulating the activator in response to the flow characteristics of the insert and hence the liquid flow through the valve body coupled to the regulator unit.

Embodiments of the invention are set forth in the dependent claims.

### LIST OF FIGURES

In the following an embodiment of the invention will be explained with reference to the figures, wherein

FIG. 1 shows a schematic drawing of the constituent functions in one embodiment of a valve system according to the invention;

FIG. 2 shows a section of an embodiment of a valve system according to the invention;

FIG. 3 shows an “exploded view” of an embodiment of a valve system according to the invention.

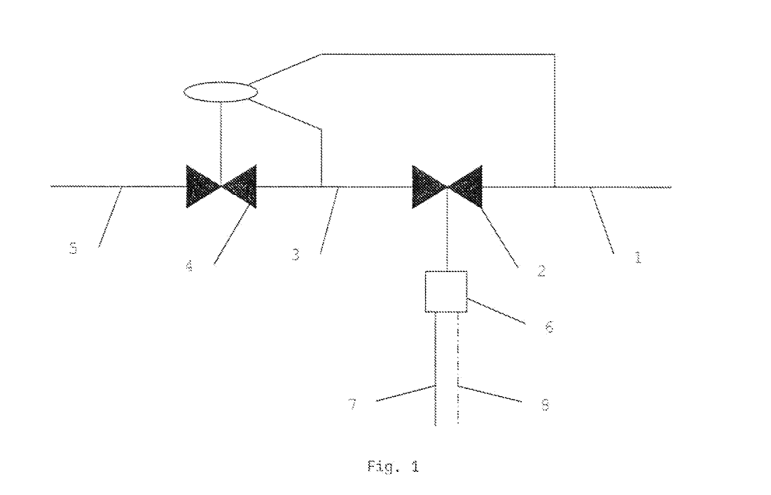

FIG. 1 shows which constituent functions are present in the valve system. The gathering of those constituent functions into one single valve system (a valve body with an insert within and a control unit mounted thereon) saves space.

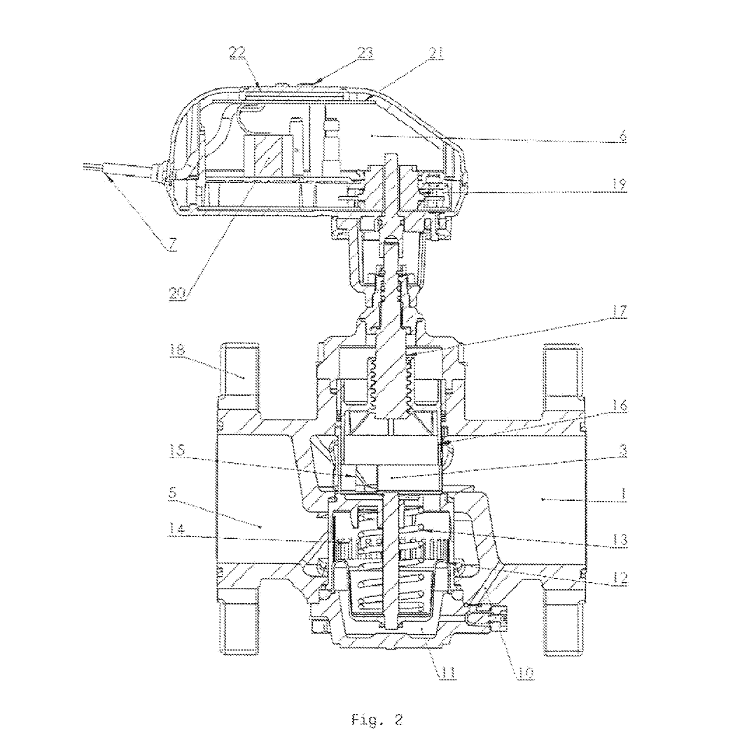

FIG. 2 shows an embodiment of a valve system for controlling the liquid flow in a plant for central heating. The system comprises one or more valve bodies 18, wherein an insert can be arranged that has specific flow characteristics. The insert comprises a regulator part and a differential-pressure part, each of which has regulable openings 14, 15. An applied change in the area of the openings 15 of the regulator unit brings about a change in the differential pressure over them, whereby the area of the openings 14 of the other unit (the differential-pressure part) is changed in response thereto. The insert is furthermore provided with means for the applied change in area by means of an activator 17 that comprises an end exposed to the surroundings.

The valve system comprises a programmable regulator unit 6 provided with motor and comprising coupling means 50 adapted to complementary coupling means 51 on the valve bodies to the effect that the motor of the regulator unit can be coupled to the end of the activator 17 on the insert. The regulator unit is programmed such that, depending on the flow characteristics of the insert, the regulator unit is capable of regulating the activator 17 and hence the liquid flow through the valve body coupled to the regulator unit.

The valve as such (the valve body with the insert) is a so-called differential-pressure-independent regulator valve that comprises two sub-functions, viz a so-called differential-pressure part 4 and a regulator part 2. The valve is coupled to an electronic control unit 6 controlling the opening area over the regulator part 2, while the differential pressure is controlled by the above-mentioned differential-pressure part 4. The electronic control unit 6 is capable of communicating with a unit outside the valve system via an input 7 and an output 8.

In the configuration shown in FIG. 2, the regulator part comprises a number of openings 15 with associated closing device 16 and an activator 17, while the differential-pressure part comprises other openings 14, a spring 13, and a diaphragm 12.

The liquid to be regulated by the valve enters via the inlet 1 and proceeds through the openings 15, and from there the liquid runs through an internal chamber 3 and out through the openings 14 of the differential-pressure part—to finally leave the valve via the outlet 5.

In the shown embodiment, the control unit 6 is applied to the top of the valve and it is provided with a motor 20 which, via a gear 19, is capable of influencing the activator 17 which, via the closing device 16, is capable of controlling the opening area of the openings 15 of the regulator part.

The pressure from the inlet 1 propagates through the passage 10 to a lower chamber 11 and presses on the underside of the diaphragm. The diaphragm can be shifted across the openings 14 and thereby it may, along with the spring 13, jointly and automatically, regulate the pressure in the internal chamber 3, the area above the openings of the differential-pressure part being changed to the effect that the differential pressure over the openings 15 of the regulator part depends on the area of the openings 14 in the differential-pressure unit.

The control unit 6 controls the area of the openings 15 of the regulator part. The control unit is programmed such that it knows or calculates the associated differential pressure over same and, by means of is that parameter, it may also calculate the flow through the plant. In a heating system with several strings, it may often be necessary to restrict the maximal flow through the individual strings to the effect that, at any time, one can make sure that the flow does not—exclusively—run in one single string. Such maximal flow value may be entered into the control unit by means of an input which may eg be a keyboard 23. Furthermore, the regulator unit is, in the figures, configured with a PCB board 21 and a screen or display 22 capable of showing various operation parameters such as current flow, temperature or the like. Of course, the screen may also be used in connection with the display of parameters in connection with the programming of the regulator unit.

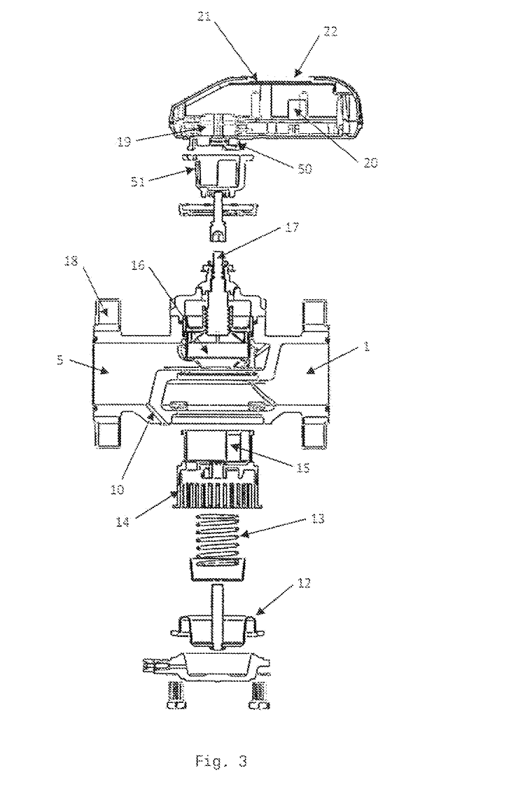

FIG. 3 shows more clearly how the openings 15 of the regulator unit as such are regulated by means of a cup-like/closing device part 16 that can be moved up or down by means of the control unit's motor and hence change the opening area of the openings 15.

The control unit can be made with a coupling part comprising three legs arranged about the shaft that is to transfer the rotation between regulator part and valve body. Those three legs are introduced by interconnection in three complementary holes in a coupling part on the valve body. That configuration ensures that the regulator unit cannot rotate relative to the valve body. From the manufacturer's, a “locking ring” is clicked onto the coupling part of the valve body. By turning, the locking ring is capable of engaging with other complementary locking means on the regulator part and hence locks the latter axially. Moreover, the locking mechanism is configured with a click mechanism which is activated when regulator unit and valve body are interconnected. Consequently, when an operator is thus to apply the regulator unit to the valve body, he/she is merely to introduce the legs and then turn the ring until he/she hears a click. Of course, the number of legs can be another number, such as 2 or 4, or an entirely different number. This is because, as mentioned above, it is the purpose of legs and holes to prevent a rotation between regulator part and valve body. It will likewise be obvious to the person skilled in the art that, instead of configuring the regulator part with legs that engage into complementary holes in the valve body, one may provide a “negative system”, wherein the valve body is configured with legs that engage with complementary holes in the regulator unit which is then also configured with a locking ring.

The control unit can be programmed such that it is capable of operating different valves which may, in turn, have different inserts.

According to one embodiment of the invention, a maximum and/or minimum value for the liquid throughput can be set in the control unit to the effect that the field of operation of the valve system is delimited.

According to one embodiment, the control unit automatically calibrates itself in accordance with the valve, the control unit registering the closing point of the valve and uses it as a starting point for the field of operation of the valve.

In case of a malfunction where the control unit is eg incapable of moving the closing device 16, it is recorded as a malfunction shown on the screen following which the control unit—at suitable intervals—repeats its attempt to move the closing device.

The purpose of this is to avoid that periodical malfunctions result in permanent breakdowns of the system, but merely hinder the functionality during the period when the malfunction occurs.

According to one embodiment, the control unit divides malfunctions into two levels—a warning about possible problems and an alarm regarding critical system failure.

According to one embodiment of the invention, certain programming options and/or data can be protected by a password which may be activated or deactivated by the operator. According to one embodiment, a certain amount of detailed data are always protected by a particular password to the effect that only advanced users have access to them. Such detailed data may eg contain the total number of malfunctions.

According to one embodiment, certain data are always available on the screen of the control unit by a push being applied to the keys of the keyboard. Such data be eg be selected settings and current values.

According to one embodiment, the control unit is moreover provided with a temperature sensor. Thereby it can be provided with a safety device that disconnects the power to the electronics or parts thereof if the temperature in the control unit exceeds a defined value.

According to one embodiment of the invention, the control unit is provided with an independent power supply to the effect that the control unit is capable of performing an action in case of power failure, such as closing the valve. One way of doing so is by providing the control unit with one or more batteries that are continuously charged and used during power failures, if any. However, it could also be accomplished by means of capacitors.

Since the control unit is programmed to be able to operate several different valves, the operator who is to replace a control unit needs to bring along only one type of unit.

According to one embodiment, the control unit may be provided with a suitable interface, such as a keyboard of wireless communication means to the effect that an operator is capable of setting the control unit in accordance with the valve type in question and the need of the plant.

One way of doing so is by providing the valve with an identification number Which is merely to be entered by the operator via the interface of the control unit. However, that could also be accomplished by the control unit, by interconnection with the valve/the insert, automatically identifying it and adjusting accordingly. According to one embodiment, this is accomplished entirely mechanically, but it could also be accomplished by providing the control unit and the valve/the insert with a wireless communications system based on eg RFID (Radio Frequency Identification) which is an automated identification method working by saving and remote-receiving data by use of devices called RFID-tags or transponders.

According to one embodiment, the movement between the control unit and valve is transferred entirely magnetically.

According to one embodiment, the valve system comprises measurement terminals to the effect that pressure and/or temperature in the system can be measured from the outside.

According to one embodiment, the passage 10 in which the inlet pressure propagates to the lower chamber 11 is provided with a screw which is accessible from the outside and by which the operator is capable of increasing or reducing the throughput area of the passage. Hereby the speed at which pressure changes propagate to the underside of the diaphragm is regulated/braked whereby the movements of the diaphragm are reduced or increased in response to current needs.

1. A valve system, for controlling liquid flow in a plant for central heating, which system comprises one or more valve bodies, wherein an insert can be arranged that has specific flow characteristics, said insert comprising two types of units with regulable openings, said units being provided with means for regulating the liquid flow, an applied change in an area of the openings of the one unit bringing about a change in differential pressure over the openings of that unit, whereby the area of the openings of the other unit is changed in response thereto, said insert being furthermore provided with means for the applied change in area by means of an activator that comprises an end which is exposed to surroundings of the valve system, said valve system comprising:
a programmable regulator unit provided with a motor that includes a coupler configured to couple to a complementary coupler on the valve bodies to the effect that the motor of the regulator unit can optionally be coupled to the end of the activator on the insert, said regulator unit being programmed such that the regulator unit is capable of regulating the activator in response to the flow characteristics of the insert and hence the liquid flow through the valve body coupled to the regulator unit.

2. The valve system according to claim 1, further comprising means for measuring a position of the activator and a unit for processing data configured for estimating the liquid flow through the valve based on the position of the activator.

3. The valve system according to claim 1, wherein the control unit is capable of influencing the activator at several different speeds depending on a magnitude of the distance it is to travel.

4. The valve system according to claim 1, further comprising means for measuring power consumption in the motor and a unit for processing data that is configured to estimate a force or a momentum by which the activator is influenced.

5. The valve system according to claim 4, wherein the control unit estimates the momentum on the basis of the power consumption in the motor.

6. The valve system according to claim 5, further comprising a switch causing the motor to stop when the force or the momentum in the activator is estimated to exceed a maximum value stored in a memory of the control unit.

7. The valve system according to claim 1, further comprising:
means for measuring a temperature in the control unit; and
a switch that turns off when the temperature is outside a range stored in the memory of the control unit.

8. The valve system according to claim 1, wherein a part of the memory of the control unit is stored on an electrically independent unit so that data are stored and accumulated.

9. The valve system according to claim 1, further comprising an interface that facilitates programming of the control unit.

10. The valve system according to claim 1, wherein the control unit comprises an interface in the form of an RFID system or an infrared system, wherein a tag arranged in association with an insert or a valve body is detected by an antenna part arranged in association with the control unit, whereby the control unit is automatically adjusted to the coupled insert.

11. The valve system according to claim 1, wherein the valve body comprises a coupling part with associated identification means; and the regulator unit comprises means capable of reading the identification means, whereby the control unit is automatically adjusted to the coupled insert.

12. The valve system according to claim 11, wherein the control unit and the valve body can be interconnected via a so-called snap-coupling; and that the identification takes place by mechanical detection of when the parts are being interconnected or have been interconnected.

13. The valve system according to claim 2, wherein the control unit is capable of influencing the activator at several different speeds depending on a magnitude of the distance it is to travel.

14. The valve system according to claim 2, further comprising means for measuring power consumption in the motor and a unit for processing data that is configured to estimate a force or a momentum by which the activator is influenced.

15. The valve system according to claim 2, further comprising:
means for measuring a temperature in the control unit; and
a switch that turns off when the temperature is outside a range stored in the memory of the control unit.

16. The valve system according to claim 2, wherein a part of the memory of the control unit is stored on an electrically independent unit so that data are stored and accumulated.

17. The valve system according to claim 2, further comprising an interface that facilitates programming of the control unit.

18. The valve system according to claim 2, wherein the control unit comprises an interface in the form of an RFID system or an infrared system, wherein a tag arranged in association with an insert or a valve body is detected by an antenna part arranged in association with the control unit, whereby the control unit is automatically adjusted to the coupled insert.

19. The valve system according to claim 2, wherein the valve body comprises a coupling part with associated identification means; and the regulator unit comprises means capable of reading the identification means, whereby the control unit is automatically adjusted to the coupled insert.

20. The valve system according to claim 3, further comprising means for measuring power consumption in the motor and a unit for processing data that is configured to estimate a force or a momentum by which the activator is influenced.
